(19) United States
(12) Patent Application Publication
(10) Pub. No.: US 2008/0134252 A1
(43) Pub. Date: Jun. 5, 2008

(54) RECORDING VIDEO BROADCASTS THAT END AT A TIME DIFFERENT THAN THE ORIGINALLY SCHEDULED TIME

(76) Inventors: Kulvir S. Bhogal, Fort Worth, TX (US); Gregory J. Boss, American Fork, UT (US); Rich A. Hamilton,II, Charlottesville, VA (US); Alexandre Polozoff, Bloomington, IL (US)

Correspondence Address: IBM CORP (YA);C/O YEE & ASSOCIATES PC, P.O. BOX 802333, DALLAS, TX, 75380, US

(21) Appl. No.: 11/566,799

(22) Filed: Dec. 5, 2006

(51) Int. Cl. G06F 3/00

(52) U.S. Cl. 725/58

(57) ABSTRACT

A computer implemented method and digital video recorder for recording a show, wherein the show comprises video and audio transmitted by a broadcaster. The digital video recorder is set to record the show at a start time, an end time, and a channel. An overtime signal is received from the broadcaster. Responsive to receiving the overtime signal, the digital video recorder determines a modified end time. The digital video recorder records the show using the start time, the modified end time, and the channel.

### BACKGROUND

1. Technical Field

The present invention relates generally to data processing systems and in particular to data processing systems for recording video. Still more particularly, the present invention relates to a computer implemented method and apparatus for recording video broadcasts that end at a time different than the originally scheduled time.

2. Description of the Related Art

A digital video recorder (DVR) is a computer that has been customized to record video. Typically, a digital video recorder has a video tuner card and special software that allows for television and cable shows to be recorded, edited, and archived on to a hard drive, and then backed up to optical disc. A digital video recorder may be programmed to record an unattended show, so that the user can view the show at a later time. To record an unattended show using a digital video recorder, a user programs the digital video recorder with the start and end times for a specific show, along with the channel the show is being broadcast on. The shows that are available for recording are usually published in a guide, along with the start and end times, and the channel the show is being broadcast on.

If the digital video recorder is recording a show and the show ends early or runs later than the published end time, then the user who programmed the recording has no way of adjusting the end time. If a show runs past the published time, the recording will lose part of the show. For example, sporting events rarely end at their published times. If a sporting event goes beyond the event's scheduled end time due to, for example, overtime or a rain delay, then the digital video recorder stops recording at the published end time. When a show runs past the published end time, the remainder of the show after the published end time is not recorded, and the user is not able to view the entire show.

### BRIEF SUMMARY

The illustrative embodiments of the present invention described herein provide a computer implemented method and digital video recorder for recording a show, wherein the show comprises video and audio transmitted by a broadcaster. The digital video recorder is set to record the show at a start time, an end time, and a channel. An overtime signal is received from the broadcaster. Responsive to receiving the overtime signal, the digital video recorder determines a modified end time. The digital video recorder records the show using the start time, the modified end time, and the channel.

### BRIEF DESCRIPTION OF THE DRAWINGS

The novel features believed characteristic of the illustrative embodiments are set forth in the appended claims. The illustrative embodiments themselves, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a network of data processing systems in which illustrative embodiments of the present invention may be implemented;

FIG. 2 is a block diagram of a data processing system in which illustrative embodiments of the present invention may be implemented;

FIG. 3 is a block diagram illustrating a digital video recorder in accordance with an illustrative embodiment of the present invention; and

FIG. 4 is a flowchart of a process in a digital video recorder in accordance with an illustrative embodiment of the present invention.

### DETAILED DESCRIPTION OF AN ILLUSTRATIVE EMBODIMENT

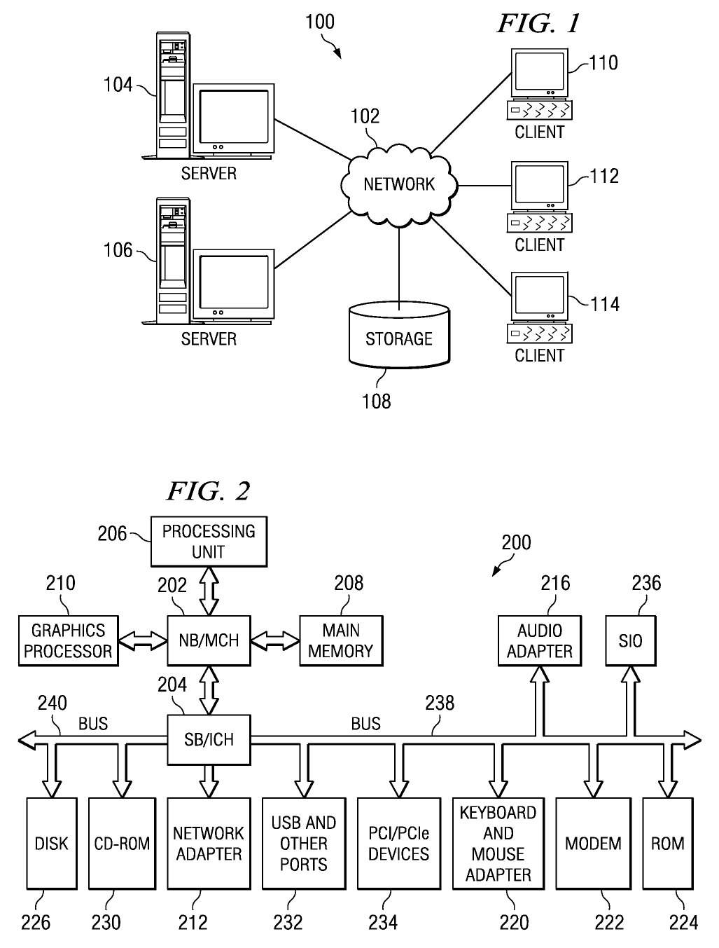

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments of the present invention may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as video files, to clients 110, 112, and 114. Clients 110, 112, and 114 are clients to server 104 in this example. Some of clients 110, 112, and 114 may be digital video recorders in these examples. Server 104 may be a source of video for these clients. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments of the present invention may be implemented. Data processing system 200 is an example of a computer, such as server 104 or client 110 in FIG. 1, in which computer usable code or instructions implementing the processes may be located for the illustrative embodiments of the present invention.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. (Java™ and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processing unit 206. The processes of the illustrative embodiments of the present invention may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments of the present invention may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

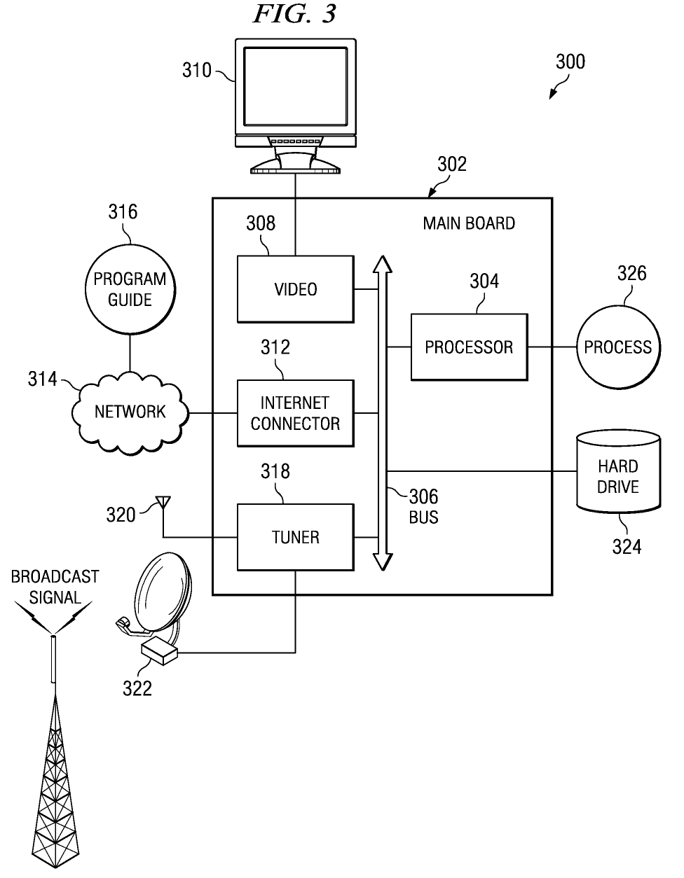

Turning now to FIG. 3, a block diagram of a digital video recorder in which an illustrative embodiment of the present invention is depicted. Digital video recorder 300 is implemented in this example using a computer, such as data processing system 200 in FIG. 2, and external components to which digital video recorder 300 connects. Digital video recorder 300 has specific hardware and software for recording, playing back, and archiving video broadcasts. Only relevant components of the digital video recorder are depicted in FIG. 3, and it should be understood that other components typically found in a data processing system may also be found in digital video recorder 300.

The term video refers to a signal that may contain both visual information and auditory information. The visual information may be encoded in a format such as, for example, national television system committee (NTSC), phase alternating by line (PAL), or motion picture experts group (MPEG). Similarly, the audio information may be encoded in a format such as, for example, motion picture experts group (MPEG), Dolby®, or digital theater system (DTS).

Main board 302 is a circuit board such as a computer motherboard, containing processor 304, and bus 306. Processor 304 executes software instructions and may be a processor, such as processor 204 in FIG. 2. Bus 306 allows the various components of main board 302 to communicate with each other, and with external components.

Video 308 is a component of main board 302 which provides a video output to an external video display, such as display 310. For example, display 310 may be a computer monitor, liquid crystal display (LCD), or a television.

Internet connector 312 is a component of main board 302 which connects main board 302 to internet 314. For example, internet connector 312 may be an Ethernet card that provides wired or wireless access to internet 314.

Program guide 316 provides a way for the user to view schedules for available shows, and then select a specific show for the digital video recorder to record. In this example, program guide 316 is shown as a website on internet 314 that provides information for programming a digital video recorder to record one or more shows. Those versed in the art will appreciate that program guide 316 may be implemented in many different ways. For example, program guide 316 may be provided through tuner 318.

Tuner 318 is a component of main board 302 which connects to an external video signal. In this example, antenna 320 and satellite dish 322 are shown as providing an external video signal to main board 302. Video 308, internet connector 312, and tuner 318 may be built-in to main board 302. Alternately, video 308, internet connector 312, and tuner 318 may be connected to main board 302 using the Personal Computer Interface (PCI) bus, or the Universal Serial Bus (USB).

Hard drive 324 is attached to bus 306, and is used to record, store, and playback video shows. Process 326 is a software or firmware program which provides the user with an interface for recording shows, playing back previously recorded shows, and storing shows on a hard drive. Process 326 may be a special software process that provides a user interface along with digital video recorder functions. For example, process 326 may allow the user to view a schedule of available shows, search or filter the available shows using the user's preferences, and then select shows for recording on to hard drive 324.

Process 326 may allow the user to record shows in many different ways. For example, process 326 may allow the user to manually enter a start time, an end time, and a channel on which to receive the show. Process 326 uses the channel to set tuner 318 so that tuner 318 can receive the specified show.

Alternately, the user may browse program guide 316, and select and click on a show. When the user clicks on a show in program guide 316, information about the show, and the action to be taken, may be provided to process 326 to schedule the show for recording. For example, when a user selects a show in program guide 316, program guide 316 may provide the selected show's start time, end time, and channel number, along with an indication that the show should be recorded to process 326. Process 326 then sets itself to record the selected show.

At the start time for the selected show, process 326 sets tuner 318 to the selected show's channel and begins recording. In a conventional system, process 326 stops recording when the selected show's end time, obtained from program guide 316, is reached. Here, however, process 326 is notified if any delay occurs so that process 326 can adjust the end time appropriately.

The broadcaster of the show sends an overtime signal embedded in the show. An overtime signal is a signal from the broadcaster which indicates that one or more shows which the broadcaster is broadcasting will end at time later than the originally scheduled end time for the show. The overtime signal informs the receiving device, such as a digital video recorder or television that one or more shows will end at a later time than the scheduled end time. The overtime signal may cause a digital video recorder to continue to record the show past the original end time so that the entire show is captured. The overtime signal may be encoded within the broadcast so that it is not directly visible to the viewer, such as in the vertical blanking interval.

The overtime signal is received by antenna 320 or satellite dish 322, and processed by tuner 318. If tuner 318 detects an overtime signal, tuner 318 notifies process 326 so that process 326 can take appropriate action. The overtime signal is sent prior to the scheduled end of the selected show so that process 326 can adjust the recording settings for the digital video recorder accordingly. The overtime signal consists of (i) an overtime state, (ii) the name of the selected show, (iii) the anticipated end time for the selected show, and (iv) a broadcast plan.

When process 326 receives the overtime signal, process 326 calculates whether the overtime recording will conflict with any other previously scheduled recordings. If there is no conflict, then process 326 continues recording the selected show past the originally scheduled end time so that the selected show is captured in its entirety. If, however, recording the show would cause a conflict with another show that the user previously programmed process 326 to record, then a conflict exists, and process 326 can use a default or previously defined conflict resolution policy to determine whether or not to record the selected show past the originally scheduled end time.

For example, a user may set the conflict policy to always give sport shows priority over non-sport shows, because non-sport shows are more likely to be rebroadcast. Alternately, the user might assign a priority to each show scheduled to be recorded, so that higher priority shows take precedence over lower priority shows. Process 326 may also use a default conflict policy in which shows that run past their scheduled end time are always recorded.

In addition, if the selected show goes into overtime and prevents a second show from being recorded, process 326 may go into program guide 316, determine when the second show will be rebroadcast, and automatically set itself to record the second show at the later time.

As previously mentioned, the overtime signal consists of (i) an overtime state, (ii) the name of the selected show, (iii) the anticipated end time for the selected show, and (iv) a broadcast plan as a result of the selected show's delay. The overtime state may be a binary state that indicates whether or not the show will run past the show's originally scheduled end time. Alternately, the overtime state may provide detailed information, such as why the selected show will run past the selected show's originally scheduled end time. The name of the selected show may indicate whether the selected show's broadcast is a premier, or a repeat.

The anticipated end time indicates when the broadcaster expects the new end time for the selected show. Finally, the broadcast plan for displaced shows provides information on the broadcaster's plan for shows scheduled to broadcast that day. For example, the broadcast plan might provide information that the show following the delayed show would be shown in its entirety, or joined in progress.

The overtime signal may be broadcast continuously, or at periodic intervals. If the overtime signal is broadcast at periodic intervals, the overtime signal may contain a date and time stamp, as well information about the frequency (period) of the overtime signal transmissions.

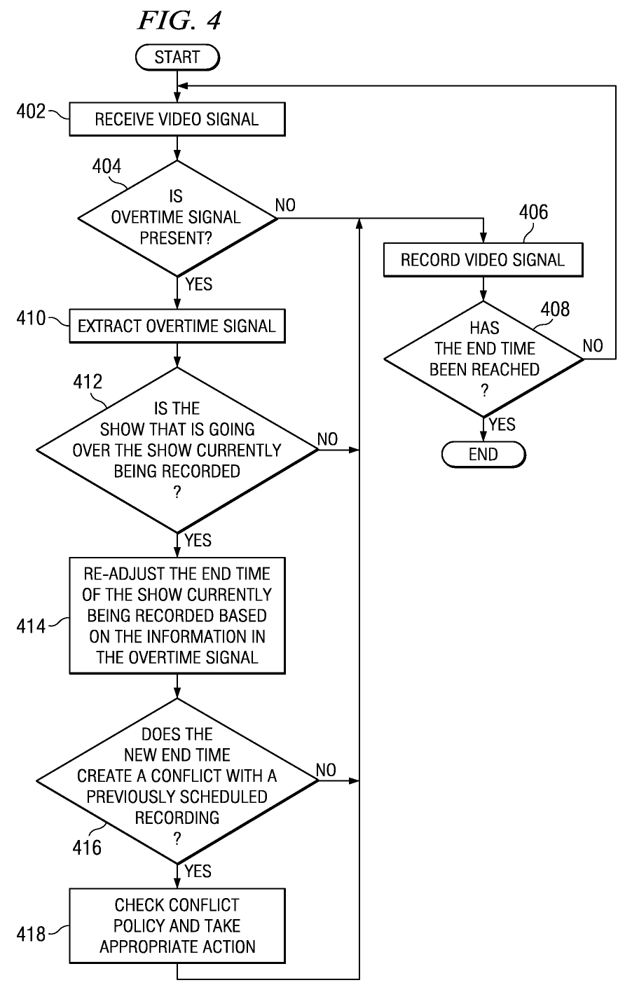

FIG. 4 is a flowchart of a process in a digital video recorder in accordance with an illustrative embodiment of the present invention. Flowchart 400 is executed by a software or firmware process, such as process 326 in FIG. 3, in a digital video recorder, such as digital video recorder 300 in FIG. 3.

The process starts with receiving a video signal (process block 402). A broadcaster may transmit the video signal over the air using a satellite, or using cable, such as coaxial cable, hybrid fiber-coaxial (HFC), or fiber optic cable. The video signal is received by a tuner, such as tuner 318, in the digital video recorder.

A determination is made whether an overtime signal is present in the video signal (process block 404). For example, the overtime signal may broadcast using the vertical blanking interval of the video signal. If no overtime signal is present, then the video signal is recorded (process block 406) on a memory device, such as hard drive 324 in FIG. 3. Next, a determination is made as to whether the end time has been reached (process block 408). If the end time has been reached, the process ends. If the end time has not been reached, then the process goes back to receiving the video signal (process block 402).

If an overtime signal is present, then the overtime signal is extracted from the video signal and the information in the overtime signal is analyzed (process block 410). A determination is made whether the show in the overtime signal is the show currently being recorded (process block 412). If the answer is “no”, and the show in the overtime signal is not the show currently being recorded, then the video signal is recorded (process block 406) and a determination is made as to whether the end time has been reached (process block 408).

If the answer is “yes”, and the show in the overtime signal is the show currently being recorded, then the end time for the show currently being recorded is adjusted based on the information in the overtime signal (process block 414). For example, if the overtime signal indicates that a football game currently being recorded is going into overtime, then the end time for the recording may be increased.

A determination is made as to whether the new end time for the show currently being recorded is in conflict with a scheduled recording (process block 416). If there is no conflict between the new end time and the scheduled recording, then the video signal is recorded (process block 406) and then a determination is made whether the end time has been reached (process block 408). If the answer is “yes”, and there is a conflict between the new end time and a scheduled recording, then a conflict policy is checked and appropriate action is taken (process block 418).

The conflict policy may be a default policy, or a policy created by the user. The conflict policy may, for example, specify that recording sport shows takes priority over recording episodic shows. The video signal is recorded (process block 406) and a determination is made as to whether the end time has been reached (process block 408).

The flowchart and block diagrams in the figures illustrate the architecture, functionality, and operation of some possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Embodiments of the present invention may be implemented entirely in hardware, entirely in software or using a combination of both hardware and software elements. In one embodiment, the invention is implemented in software, including but not being limited to firmware, resident software, microcode, or the like.

Furthermore, the invention can take the form of a computer program product accessible from a computer-usable or computer-readable medium providing program code for use by, or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a communication medium (e.g., a system bus). The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention embodiments in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for recording a show, where the show comprises video and audio transmitted by a broadcaster, the computer implemented method comprising:
setting a start time, an end time, and a channel for recording a first show;
receiving an overtime signal from the broadcaster;
responsive to receiving the overtime signal, determining a modified end time; and
recording the first show using the start time, the modified end time, and the channel.

2. The computer implemented method of claim 1, further comprising:
setting a start time, an end time, and a channel for recording a second show;
responsive to determining the modified end time for the first show, determining whether the modified end time for the first show conflicts with the start time for the second show;
upon determining that the modified end time for the first show conflicts with the start time for the second show, determining an action based on a conflict policy; and
performing the action.

3. The computer implemented method of claim 1, wherein the overtime signal is received continuously from the broadcaster.

4. The computer implemented method of claim 1, wherein the overtime signal is periodically received from the broadcaster.

5. A digital video recorder for recording one or more shows, wherein the one or more shows comprise video and audio transmitted by a broadcaster, the digital video recorder comprising:
a bus;
a storage device connected to the bus, wherein the storage device contains computer usable code, and wherein the storage device is used to record, store, and play back the one or more shows;
a communications unit connected to the bus;
a tuner connected to the bus, wherein the tuner receives the one or more shows; and
a processing unit connected to the bus, wherein the processing unit sets a start time, an end time, and a channel for recording a first show, receives an overtime signal from the broadcaster and responsive to receiving the overtime signal, determines a modified end time, and records the first show using the start time, the modified end time, and the channel.

6. The digital video recorder of claim 5, further wherein the processing unit sets a start time, an end time, and a channel for recording a second show, responsive to determining the modified end time for the first show, the processing unit determines whether the modified end time for the first show conflicts with the start time for the second show, determines whether the modified end time for the first show conflicts with the start time for the second show, determines an action based on a conflict policy, and performs the action.

7. The digital video recorder of claim 5, wherein the processing unit receives the overtime signal continuously.

8. The digital video recorder of claim 5, wherein the processing unit receives the overtime signal periodically.
